(19) United States
(12) Patent Application Publication
(10) Pub. No.: US 2021/0382260 A1
(43) Pub. Date: Dec. 9, 2021

(54) LENS ASSEMBLY AND ELECTRONIC DEVICE HAVING THE LENS ASSEMBLY

(71) Applicant: HON HAI PRECISION INDUSTRY CO., LTD., New Taipei (TW)

(72) Inventors: GWO-YAN HUANG, New Taipei (TW); CHIA-CHIH YU, New Taipei (TW); TING-WEI YU, New Taipei (TW)

(21) Appl. No.: 17/079,128

(22) Filed: Oct. 23, 2020

(30) Foreign Application Priority Data
Jun. 5, 2020 (CN) 202010504853.4

(51) Int. Cl. G02B 7/02; G02B 13/00; G02B 9/04; H04N 5/225

(52) U.S. Cl. CPC G02B 7/021; H04N 5/2254; G02B 9/04; G02B 13/003

(57) ABSTRACT

A lens assembly has an optical axis. The lens assembly includes a first lens and a second lens stacked on a side of the first lens along the optical axis. A mounting groove is recessed from a surface of the first lens facing the second lens, the mounting groove is arranged around the optical axis and coaxially with the first lens. A protruding portion is protruded from a surface of the second lens facing the first lens to match the mounting groove, the protruding portion is arranged around the optical axis and coaxially with the second lens. The protruding portion is received in the mounting groove. The disclosure also provides an electronic device having the lens assembly.

### FIELD

The subject matter herein generally relates to an optical component, and more particularly, to a lens assembly, and an electronic device having the lens assembly.

### BACKGROUND

Optical lens modules are widely used in electronic devices. In a process of assembling lenses to form the optical lens modules, a relative arrangement relationship between the lenses may affect the imaging quality of the optical lens modules.

Therefore, there is room for improvement within the art.

### BRIEF DESCRIPTION OF THE DRAWINGS

Implementations of the present technology will now be described, by way of example only, with reference to the attached figures.

FIG. 1 is a diagram of an embodiment of a lens assembly.

FIG. 2 is an exploded, diagrammatic view of the lens assembly of FIG. 1.

FIG. 3 is a diagram of an embodiment of an electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to illustrate details and features of the present disclosure better. The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one.”

The term “comprising” when utilized, means “including, but not necessarily limited to”; it specifically indicates open-ended inclusion or membership in the so-described combination, group, series, and the like.

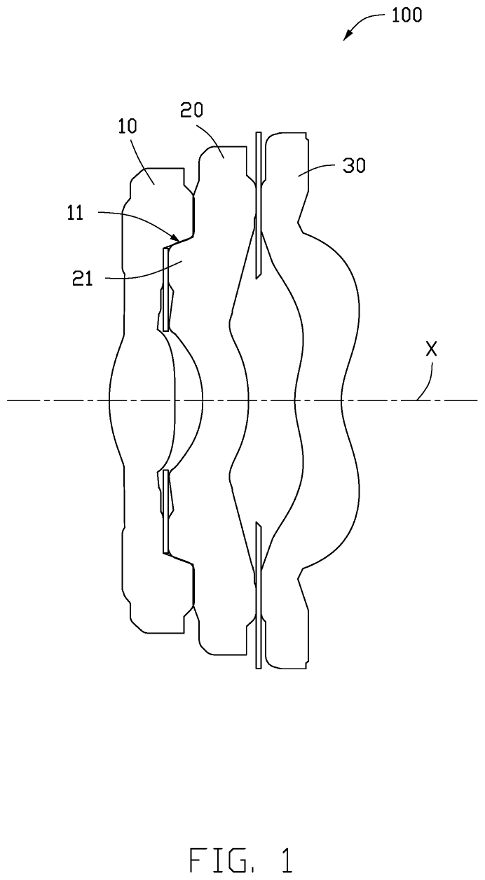

FIG. 1 illustrates an embodiment of a lens assembly 100 having an optical axis X. The lens assembly 100 includes a first lens 10 and a second lens 20. The second lens 20 is stacked with the first lens 10 along the optical axis X. A mounting groove 11 is recessed from a surface of the first lens 10 facing the second lens 20. The mounting groove 11 is arranged around the optical axis X and coaxially with the first lens 10. A protruding portion 21 is protruded from a surface of the second lens 20 facing the first lens 10 to match the mounting groove 11. The protruding portion 21 is arranged around the optical axis X and coaxially with the second lens 20. The protruding portion 21 is received in the mounting groove 11. So that the first lens 10 and the second lens 20 may be kept coaxially aligned, thereby improving the stability of the lens assembly 100 and suppressing stray light of the lens assembly 100.

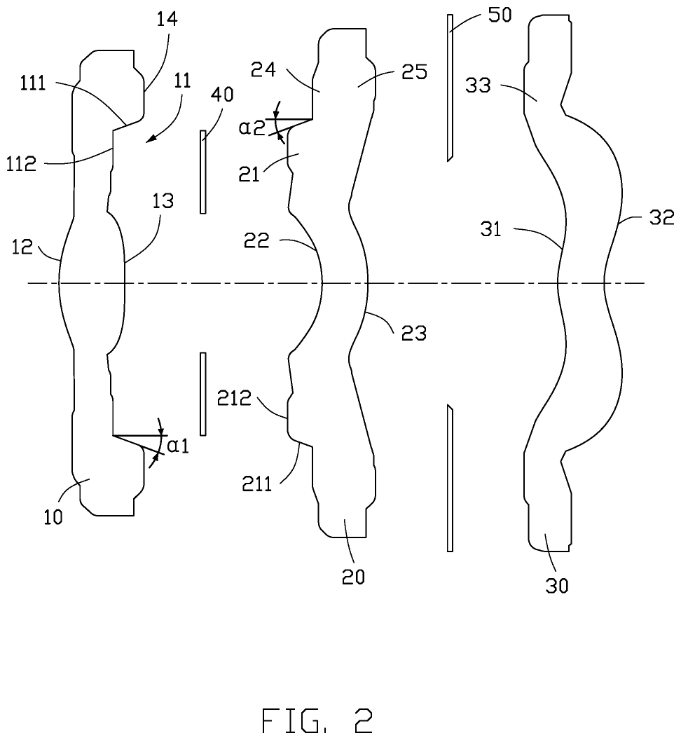

In at least one embodiment, referring to FIG. 2, the first lens 10 includes a sidewall 111 and a bottom surface 112 to cooperate to define the mounting groove 11. The sidewall 111 surrounds the optical axis X. The sidewall 111 is substantially a sidewall of a circular truncated cone connecting a circular upper surface of the circular truncated cone and a circular bottom surface of the circular truncated cone. An end portion of the sidewall 111 connecting the bottom surface 112 is closer to the optical axis X than an end portion of the sidewall 111 away from the bottom surface 112. A diameter of the mounting groove 11 gradually increases along a direction from the bottom surface 112 toward the surface of the first lens 10 facing the second lens 20.

The protruding portion 21 is substantially in a shape of a circular truncated cone. A diameter of the protruding portion 21 gradually increases along a direction from a surface 212 of the protruding portion 21 facing away from the second lens 20 toward the surface of the second lens 20 facing the first lens 10. When the first lens 10 and the second lens 20 are stacked, the mounting groove 11 is sleeved on the protruding portion 21. The protruding portion 21 includes a sidewall 211 connecting the surface of the protruding portion 21 facing away from the second lens 20 and the surface of the second lens 20 facing the first lens 10. The sidewall 211 of the protruding portion 21 abuts the sidewall 111, thereby achieving a coaxial alignment of the first lens 10 and the second lens 20 and improving a stability of the lens assembly 100. So that an actual optical path of the lens assembly 100 and a simulated optical path of the lens assembly 100 may be as consistent as possible, thereby improving an imaging quality of the lens assembly.

In at least one embodiment, a minimum diameter of the mounting groove 11 is in a range of 0.03 mm to 0.28 mm. A surface of the first lens 10 facing away from the second lens 20 has a first effective optical area 12 approximately corresponding to a center of the first lens 10. A diameter of the first effective optical area 12 is less than or equal to the minimum diameter of the mounting groove 11. A periphery of the first effective optical area 12 is separated from the sidewall 111 or corresponds to the sidewall 111 along a radial direction of the mounting groove 11. Light enters the lens assembly 100 from the first effective optical area 12. The surface of the first lens 10 facing the second lens 20 has a second effective optical area 13. The second effective optical area 13 is located on the bottom surface 112. The first effective optical area 12 and the second effective optical area 13 are substantially coaxially arranged.

The surface of the second lens 20 facing the first lens 10 has a third effective optical area 22 corresponding to a center of the protruding portion 21, and a surface of the second lens facing away from the first lens 10 has a fourth effective optical area 23. The third effective optical area 22 is approximately located at a center of an ending surface 212 of the protruding portion 21 facing the first lens 10. The third effective optical area 22 and the third effective optical area 22 are substantially coaxially arranged. Referring to FIG. 1, the third effective optical area 22 and the second effective optical area 13 are spaced from each other.

In at least one embodiment, an inclined angle al between the sidewall 111 and a central axis of the first lens 10 is in a range of 5° to 35°. In at least one embodiment, an inclined angle a2 between the sidewall 211 and a central axis of the second lens 20 is in a range of 5° to 35°. The inclined angle al may be approximately equal to the inclined angle al to improve a coaxial alignment effect of the first lens 10 and the second lens 20.

In at least one embodiment, an internal thread (not shown) may be formed on the sidewall 111, and an external thread (not shown) may be formed on the sidewall 211. The internal thread on the sidewall 111 cooperates with the external thread on the sidewall 211 to fix the first lens 10 and the second lens 20 together.

In at least one embodiment, the first lens 10 further includes a first supporting portion 14, and the second lens 20 further includes a second supporting portion 24. The first supporting portion 14 is arranged around the mounting groove 11 and located on the surface of the first lens 10 facing the second lens 20. The second supporting portion 24 is arranged around the protruding portion 21 and located on the surface of the second lens 20 facing the first lens 10. When the protruding portion 21 is received in the mounting groove 11, the first supporting portion 14 abuts the second supporting portion 24 to improve stability between the first lens 10 and the second lens 20.

The lens assembly 100 may further include a first shading sheet 40 received in the mounting groove 11. The first shading sheet 40 is sandwiched between the first lens 10 and the second lens 20 to shield stray light passing through the first lens 10, thereby improving the imaging quality of the lens assembly 100. Specifically, when the protruding portion 21 is received in the mounting groove 11, the first shading sheet 40 is sandwiched between the first supporting portion 14 and the second supporting portion 24. The first shading sheet 40 may be a circular ring.

The lens assembly 100 may further include a lens barrel (not shown) and a third lens 30. The third lens 30 is stacked on the surface of the second lens 20 facing away from the first lens 10 to improve the processing accuracy of light, thereby improving the imaging quality of the lens assembly 100. The first lens 10, the second lens 20, and the third lens 30 are received and fixed in the lens barrel.

Referring to FIGS. 1 and 2, a surface of the third lens 30 facing the second lens 20 has a fifth effective optical area 31 corresponding to a center of the third lens 30. The fifth effective optical area 31 and the fourth effective optical area 23 are spaced from each other. A surface of the third lens 30 facing away from the second lens 20 has a sixth effective optical area 32. The sixth effective optical area 32 and the fifth effective optical area 31 are substantially coaxially arranged.

The second lens 20 may further include a third supporting portion 25 on the surface of the second lens 20 facing the third lens 30, and the third lens 30 further includes a fourth supporting portion 33 facing and corresponding to the third supporting portion 25. When the second lens 20 and the third lens 30 are stacked, the third supporting portion 25 abuts the fourth supporting portion 33.

A second shading sheet 50 may be located between the second lens 20 and the third lens 30. The second shading sheet 50 is sandwiched between the third supporting portion 25 and the fourth supporting portion 33 to shield stray light passing through the second lens 20.

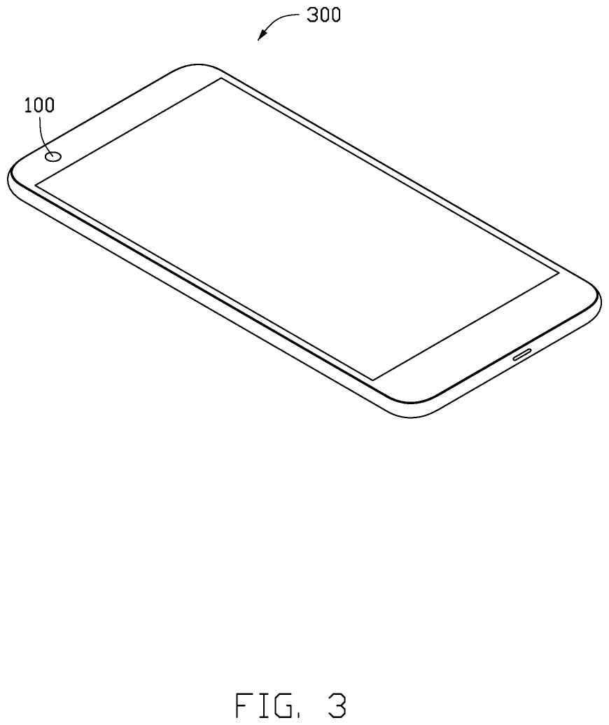

Referring to FIG. 3, The lens assembly 100 may be applied in an electronic device 300, such as a phone or a computer.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A lens assembly having an optical axis, the lens assembly comprising:
a first lens;
a second lens stacked on a side of the first lens along the optical axis;
wherein a mounting groove is recessed from a surface of the first lens facing the second lens, the mounting groove is arranged around the optical axis and coaxially with the first lens, a protruding portion is protruded from a surface of the second lens facing the first lens to match the mounting groove, the protruding portion is arranged around the optical axis and coaxially with the second lens, the protruding portion is received in the mounting groove.

2. The lens assembly of claim 1, wherein the first lens comprises a sidewall and a bottom surface to cooperate to define the mounting groove, the sidewall surrounds the optical axis, the sidewall is a sidewall of a circular truncated cone connecting a circular upper surface of the circular truncated cone and a circular bottom surface of the circular truncated cone, an end portion of the sidewall connecting the bottom surface is closer to the optical axis than an end portion of the sidewall away from the bottom surface.

3. The lens assembly of claim 2, wherein the protruding portion is in a shape of a circular truncated cone, a diameter of the protruding portion gradually increases along a direction from a surface of the protruding portion facing away from the second lens toward the surface of the second lens facing the first lens.

4. The lens assembly of claim 3, wherein the protruding portion comprises a sidewall connecting the surface of the protruding portion facing away from the second lens and the surface of the second lens facing the first lens, the sidewall of the protruding portion abuts the sidewall of the mounting groove.

5. The lens assembly of claim 4, wherein an inclined angle between the sidewall of the protruding portion and a central axis of the second lens is in a range of 5° to 35°.

6. The lens assembly of claim 2, wherein a minimum diameter of the mounting groove is in a range of 0.03 mm to 0.28 mm.

7. The lens assembly of claim 2, wherein an inclined angle between the sidewall of the mounting groove and a central axis of the first lens is in a range of 5° to 35°.

8. The lens assembly of claim 1, wherein the first lens further comprises a first supporting portion, and the second lens further comprises a second supporting portion, the first supporting portion is arranged around the mounting groove and located on the surface of the first lens facing the second lens, the second supporting portion is arranged around the protruding portion and located on the surface of the second lens facing the first lens, the first supporting portion abuts the second supporting portion.

9. The lens assembly of claim 1, wherein the lens assembly further comprises a first shading sheet received in the mounting groove, the first shading sheet is sandwiched between the first lens and the second lens.

10. An electronic device comprising:
a lens assembly having an optical axis, the lens assembly comprising:
a first lens;
a second lens stacked on a side of the first lens;
wherein a mounting groove is recessed from a surface of the first lens facing the second lens, the mounting groove is arranged around the optical axis and coaxially with the first lens, a protruding portion is protruded from a surface of the second lens facing the first lens to match the mounting groove, the protruding portion is arranged around the optical axis and coaxially with the second lens, the protruding portion is received in the mounting groove.

11. The electronic device of claim 10, wherein the first lens comprises a sidewall and a bottom surface to cooperate to define the mounting groove, the sidewall surrounds the optical axis, the sidewall is a sidewall of a circular truncated cone connecting a circular upper surface of the circular truncated cone and a circular bottom surface of the circular truncated cone, an end portion of the sidewall connecting the bottom surface is closer to the optical axis than an end portion of the sidewall away from the bottom surface.

12. The electronic device of claim 11, wherein the protruding portion is in a shape of a circular truncated cone, a diameter of the protruding portion gradually increases along a direction from a surface of the protruding portion facing away from the second lens toward the surface of the second lens facing the first lens.

13. The electronic device of claim 12, wherein the protruding portion comprises a sidewall connecting the surface of the protruding portion facing away from the second lens and the surface of the second lens facing the first lens, the sidewall of the protruding portion abuts the sidewall of the mounting groove.

14. The electronic device of claim 13, wherein an inclined angle between the sidewall of the protruding portion and a central axis of the second lens is in a range of 5° to 35°.

15. The electronic device of claim 11, wherein a minimum diameter of the mounting groove is in a range of 0.03 mm to 0.28 mm.

16. The electronic device of claim 11, wherein an inclined angle between the sidewall of the mounting groove and a central axis of the first lens is in a range of 5° to 35°.

17. The electronic device of claim 10, wherein the first lens further comprises a first supporting portion, and the second lens further comprises a second supporting portion, the first supporting portion is arranged around the mounting groove and located on the surface of the first lens facing the second lens, the second supporting portion is arranged around the protruding portion and located on the surface of the second lens facing the first lens, the first supporting portion abuts the second supporting portion.

18. The electronic device of claim 10, wherein the lens assembly further comprises a first shading sheet received in the mounting groove, the first shading sheet is sandwiched between the first lens and the second lens.
